(19) United States
(12) Patent Application Publication
(10) Pub. No.: US 2017/0023131 A1
(43) Pub. Date: Jan. 26, 2017

(54) METHOD AND DEVICE FOR CONTROLLING SHIFTING OF AUTOMATED MANUAL TRANSMISSION

(71) Applicant: HYUNDAI DYMOS INCORPORATED, Seosan-si Chungcheongnam-do (KR)

(72) Inventor: Dae Kyun KIM, Hwaseong-si Gyeonggi-do (KR)

(73) Assignee: HYUNDAI DYMOS INCORPORATED, Seosan-si Chungcheongnam-do (KR)

(21) Appl. No.: 15/124,919

(22) PCT Filed: Mar. 9, 2015
(86) PCT No.: PCT/KR2015/002239

§ 371 Date: Sep. 9, 2016

(30) Foreign Application Priority Data
Mar. 10, 2014 (KR) 10-2014-0027843

(51) Int. Cl. F16H 61/12; F16H 63/30; F16D 23/02; F16H 61/28

(52) U.S. Cl. CPC F16H 61/12; F16H 61/28; F16H 63/30; F16D 23/02; F16H 2063/3093; F16H 2061/1256

(57) ABSTRACT

The present disclosure provides a method and device for controlling shifting of an automated manual transmission. The method includes: a shifting-attempting step of attempting to shift to a desired transmission gear by axially moving a clutch unit in a transmission to the desired transmission gear; a rotating step of rotating the clutch unit within a predetermined rotation section by rotating a shaft when the clutch unit fails to engage with the desired transmission gear in the shifting-attempting step; and a re-shifting-attempting step of reattempting to shift to the desired transmission gear by axially moving the clutch unit to the desired transmission gear.

### FIELD

The present disclosure relates to control of shifting of an automated manual transmission. More particularly, it relates to a method and device for controlling shifting of an automated manual transmission, the method and device allowing use of a small shifting force for changing gears by rotating an input shaft having relatively large inertia by a predetermined rotation section when a gear change process has failed.

### BACKGROUND

In general, in a synchromesh transmission used for a manual transmission, when force that moves a shift lever is transmitted through a shift mechanism, the rotational speeds of transmission gears on an input shaft and an output shaft are synchronized and then the gears are engaged, thereby preventing shifting shock.

That is, when a shift lever is operated, a sleeve is pushed to a corresponding transmission gear and friction is generated between a friction side of a synchronizer ring and a friction side of the transmission gear, thereby achieving synchronization. When the sleeve is further pushed to the transmission gear, a shift gear formed at the sleeve is engaged with a synch gear of the synchronizer ring and a clutch gear of the transmission gear, whereby shifting is performed.

Meanwhile, in a hybrid vehicle equipped with an automated manual transmission, shifting is performed by an actuator, and a clutch part on an input shaft and a driving motor are operated by larger inertia when the actuator, which requires a large shifting force, performs shifting to start a vehicle.

That is, the inertia in the input shaft must be small or the actuator must have large shifting force such that it can perform shifting against the inertia in order to smoothly engage a shift gear on a sleeve and a clutch gear on a transmission gear.

However, when the end of the shift gear and the end of the clutch gear directly hit against each other during shifting, if the shifting force of the actuator is not enough against the hitting, the shift gear is not engaged with the clutch gear and separated. This is called baulking.

In order to solve this problem, there are some methods in the related art, such as changing the shapes of a shift gear and a clutch gear or increasing the shift torque from a gear actuator. However, these methods require new design of hardware and changes in specification of manual transmissions, which increases the manufacturing cost of vehicles.

A “Synchronizer of manual transmission for a vehicle” has been proposed in Korean Patent Application Publication No. 10-2012-0003635 in the related art.

However, this invention could not solve the problem that shifting is not performed due to hitting of a shift gear and a clutch gear.

The description provided above as a related art of the present disclosure is only for helping understanding the background of the present disclosure and should not be construed as being included in the related art known by those skilled in the art.

### SUMMARY

The present disclosure is to provide a method and device for controlling shifting of an automated manual transmission, the method and device allowing for use of a small shifting force for changing gears by rotating an input shaft having relatively large inertia by a predetermined rotation section when it is failed to change gears.

One aspect of the present disclosure provides a method of controlling shifting of an automated manual transmission. The method includes: a shifting-attempting step of attempting to shift to a desired transmission gear by axially moving a clutch unit in a transmission to the desired transmission gear; a rotating step of rotating the clutch unit within a predetermined rotation section by rotating a shaft when the clutch unit fails to engage with the desired transmission gear in the shifting attempting step; and a re-shifting-attempting step of reattempting to shift to the desired transmission gear by axially moving the clutch unit to the desired transmission gear.

The shaft that is rotated in the rotating step may be an input shaft and the input shaft may rotate by rotational displacement such that a shift gear of a sleeve in the clutch unit is positioned inside clutch gears formed on a transmission gear.

The input shaft may be rotated by power from an engine by engaging a clutch in the rotating step.

When a driving motor is installed on the input shaft, the input shaft may be rotated by operating the driving motor in the rotating step.

The rotating step may be performed when a vehicle is stopped.

The clutch unit may be a synchromesh shifting unit disposed on an input shaft or an output shaft.

According to another aspect of the present disclosure, there is provided a device for controlling shifting of an automated manual transmission. The device includes a control unit that attempts to shift to a desired transmission gear by axially moving a clutch unit in a transmission to the desired transmission gear, rotates the clutch unit within a predetermined rotation section by rotating a shaft when the clutch unit fails to engage with the desired transmission gear, and reattempts to shift to the desired transmission gear by axially moving the clutch unit to the transmission gear.

According to the present disclosure, when shifting by engagement of a transmission gear and the clutch unit fails due to insufficient shifting force that is caused by inter-teeth contact between the clutch gear and a shift gear of the clutch unit, the clutch unit is finely rotated with a shaft and then shifting to the transmission gear is performed again, whereby the sleeve can be smoothly engaged with the clutch gear only by using a small shifting force of the actuator, thereby improving shifting ability. Further, specifications of common manual transmissions are not required to be changed, so productivity is increased. Further, the shapes of the clutch gear and the shift gear are simplified, productivity of parts and price competitiveness are secured.

Further, when a vehicle is started, the starting ability and the commercial value of the vehicle are improved by quick engagement of gears. Furthermore, the frequency of retrying to shift when a vehicle is started is reduced, so the vehicle can be quickly started, deformation and wear of hardware are prevented, and the shifting performance can be maintained for a long period of time.

### DRAWINGS

FIG. 1 is a flowchart showing a method of controlling shifting of an automated manual transmission according to the present disclosure;

FIG. 2 is a view showing the configuration of an automated manual transmission according to the present disclosure; and

FIG. 3 is a view schematically showing a clutch unit for achieving the method of controlling shifting of an automated manual transmission according to the present disclosure.

### DETAILED DESCRIPTION

Exemplary forms of the present disclosure will be described hereafter in detail with reference to the accompanying drawings.

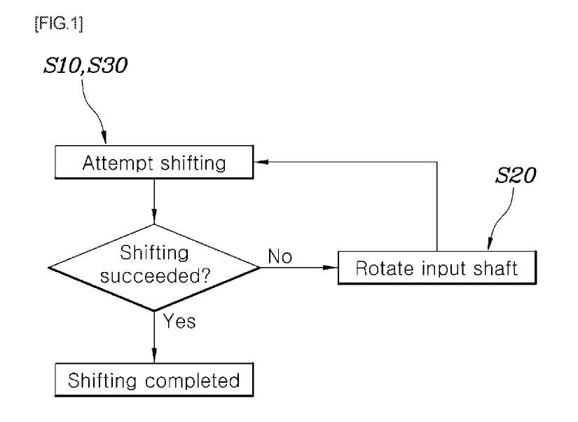

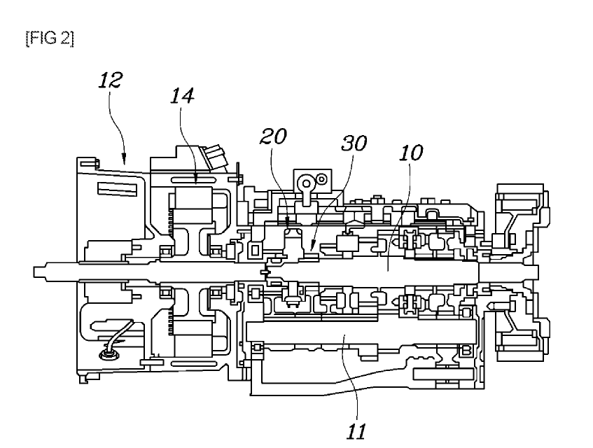

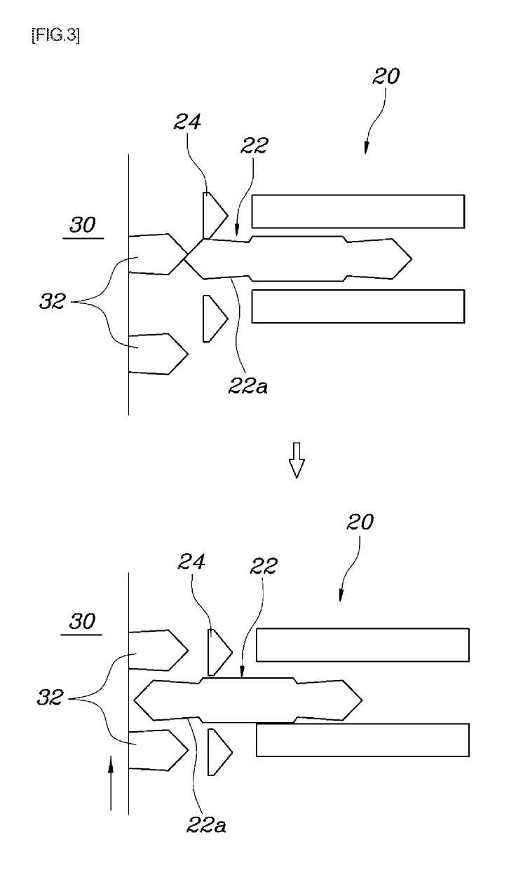

FIG. 1 is a flowchart showing a method of controlling shifting of an automated manual transmission according to the present disclosure, FIG. 2 is a view showing the configuration of an automated manual transmission according to the present disclosure, and FIG. 3 is a view schematically showing a clutch unit for achieving the method of controlling shifting of an automated manual transmission according to the present disclosure.

A method of controlling shifting of an automated manual transmission of the present disclosure broadly includes a shifting-attempting step (S10), a rotating step (S20), and a re-shifting-attempting step (S30).

The present disclosure will be described in detail hereafter with reference to FIGS. 1 to 3. The method of controlling shifting of an automated manual transmission of the present disclosure includes: a shifting-attempting step S10 that attempts to shift to a desired transmission gear 30 by axially moving a clutch unit 20 in a transmission to the desired transmission gear 30; a rotating step S20 that rotates the clutch unit 20 within a predetermined rotation section by rotating a shaft when the clutch unit 20 fails to engage with the desired transmission gear 30 in the shifting-attempting step S10; and a re-shifting-attempting step S30 that reattempts to shift to the desired transmission gear 30 by axially moving the clutch unit 20 to the desired transmission gear 30.

The clutch unit 20 may be disposed on an input shaft 10 or an output shaft 11 and it may be a synchromesh shifting unit. The clutch unit 20 may be operated by a gear actuator.

Further, as shown in FIG. 3, the part that is moved to the transmission gear 30 is a sleeve 22 of the clutch unit 20, so when the sleeve 22 engages with a clutch gear 32 formed on the transmission gear 30, shifting is achieved.

According to this configuration, when shifting by engagement of the transmission gear 30 and the clutch unit 20 fails due to insufficient shifting force that is caused by inter-teeth contact between the clutch gear 32 and a shift gear 22a of the clutch unit 20, the contact between the shift gear 22a and the clutch gear 32 is reduced by finely rotating the clutch unit 20 and then shifting to the transmission gear 30 is performed again.

Accordingly, the sleeve 22 can be smoothly engaged with the clutch gear 22 only by small shifting force of the actuator, thereby improving shifting ability. Further, specifications of common manual transmissions are not required to be changed, so productivity is increased. Further, the shapes of the clutch gear 32 and the shift gear 22a are simplified, productivity of parts and price competitiveness are secured.

According to the present disclosure, the shaft that is rotated in the rotating step S20 is the input shaft 10 and the input shaft 10 can be rotated such that the sleeve 22 of the clutch unit 20 can be positioned inside the clutch gear 32 of the transmission gear 30. That is the input shaft 10 can be rotated by a section defined by the rotational displacement.

Further, as shown in FIG. 2 when a driving motor 14 and a clutch 12 that have large inertia are disposed on the input shaft 10, shifting can be performed well by the shifting force of a relatively small actuator by rotating the input shaft 10 having large inertia.

According to the present disclosure, it is possible to rotate the input shaft 10 with power from an engine by engaging the clutch 12 in the rotating step S20.

By controlling slip of the clutch 12, power from the engine can be transmitted to the input shaft 10, whereby the input shaft 10 can be rotated.

Further, according to the present disclosure, it is possible to rotate the input shaft 10 by operating the driving motor 14 in the rotating step S20, when the driving motor 14 is installed on the input shaft 10.

That is, in a hybrid vehicle, an engine and the driving motor 14 are provided as driving sources, so it is possible to rotate the input shaft 10 by operating the driving motor 14.

Further, according to the present disclosure, the rotating step S20 may be performed when a vehicle is stopped.

That is, when a vehicle is started, the starting ability and the commercial value of the vehicle are improved by quick engagement of gears. Further, the frequency of retrying to shift when a vehicle is started is reduced, so the vehicle can be quickly started, deformation and wear of hardware are prevented, and the shifting performance can be maintained for a long period of time.

However, the rotating step S20 may be performed even while a vehicle runs, if necessary.

A device for controlling shifting of an automated manual transmission according to the present disclosure can be controlled by a control unit.

In detail, the device of controlling shifting of an automated manual transmission of the present disclosure includes: a control unit that attempts to shift to the desired transmission gear 30 by axially moving the clutch unit 20 in a transmission to the transmission gear 30, rotates the clutch unit 20 within a predetermined rotation period by rotating a shaft when the clutch unit 20 fails to engage with the transmission gear 30; and reattempts to shift to the transmission gear 30 by axially moving the clutch unit 20 to the transmission gear 30.

The control unit may be a TCU (Transmission Control Unit) or a higher-class control unit.

The method of shifting of the present disclosure is described hereafter through an example.

Assuming that the transmission gear 30 to shift is a gear for shifting to the first stage and the clutch unit 20 is disposed on the input shaft 10 coaxially with the first stage input gear, in the shifting-attempting step S10, the sleeve 22 of the clutch unit 20 is moved to the first stage input gear for shifting to the first stage by an actuator the shift gear 22a on the sleeve 22 engages with the clutch gear 32 on the first stage input gear through a synch gear of a synchronizer ring, whereby shifting is attempted.

When the shift gear 22a hits against the clutch gear 32 in the shifting-attempting step S10, if the shifting force of the actuator is not enough to engage the shift gear 22a with the clutch gear 32, the shift gear 22a returns without engaging with the clutch gear 32.

In this case, the input shaft 10 is rotated within a predetermined section defined by predetermined displacement in the rotating step S20, so the clutch unit 20 is rotated with the input shaft 10.

Next, in the re-shifting-attempting step S30, the sleeve 22 is moved again to the first stage input gear for shifting to the first stage by the actuator so that the shift gear 22a engages with the clutch gear 32 on the first stage input gear, whereby shifting is reattempted.

However, in this case, since the input shaft 10 and the clutch unit 20 have been finely rotated, the teeth of the shift gear 22a on the sleeve 22 are fitted among the teeth of the clutch gear 32, so the sleeve 22 is smoothly engaged with the clutch gear 32 even only by small shifting force of the actuator, whereby shifting ability is improved.

Although a form of the present disclosure has been described for illustrative purposes, those skilled in the art will appreciate that various modifications, additions and substitutions are possible, without departing from the scope and spirit of the present disclosure.

1. A method of controlling shifting of an automated manual transmission, the method comprising:
a shifting-attempting step of attempting to shift to a desired transmission gear by axially moving a clutch unit in a transmission to the desired transmission gear;
a rotating step of rotating the clutch unit within a predetermined rotation section by rotating a shaft when the clutch unit fails to engage with the desired transmission gear in the shifting-attempting step; and
a re-shifting-attempting step of reattempting to shift to the desired transmission gear by axially moving the clutch unit to the desired transmission gear.

2. The method of claim 1, wherein the shaft that is rotated in the rotating step is an input shaft and the input shaft rotates by a rotational displacement such that a shift gear of a sleeve in the clutch unit is positioned inside clutch gears formed on a transmission gear.

3. The method of claim 2, wherein the input shaft is rotated by power from an engine by engaging a clutch in the rotating step.

4. The method of claim 2, wherein when a driving motor is installed on the input shaft, the input shaft is rotated by operating the driving motor in the rotating step.

5. The method of claim 2, wherein the rotating step is performed when a vehicle is stopped.

6. The method of claim 1, wherein the clutch unit is a synchromesh shifting unit disposed on an input shaft or an output shaft.

7. A device for controlling shifting of an automated manual transmission, the device comprising:
a control unit configured to attempt to shift to a desired transmission gear by axially moving a clutch unit in a transmission to the desired transmission gear and configured to rotate the clutch unit within a predetermined rotation section by rotating a shaft when the clutch unit fails to engage with the desired transmission gear wherein the control unit reattempts to shift to the desired transmission gear by axially moving the clutch unit to the desired transmission gear.
